(19) United States
(12) Patent Application Publication
(10) Pub. No.: US 2018/0029582 A1
(43) Pub. Date: Feb. 1, 2018

(54) Brake Cylinder of a Motor Vehicle

(71) Applicant: KNORR-BREMSE Systeme fuer Nutzfahrzeuge GmbH, Muenchen (DE)

(72) Inventors: Johann EGLSEDER, Aldersbach (DE); Christoph KAISER, Aidenbach (DE); Roland KRISTL, Wegscheid (DE)

(21) Appl. No.: 15/727,166

(22) Filed: Oct. 6, 2017

Related U.S. Application Data
(63) Continuation of application No. PCT/EP2016/057603, filed on Apr. 7, 2016.

(30) Foreign Application Priority Data
Apr. 9, 2015 (DE) 10 2015 105 349.7

(51) Int. Cl. B60T 17/08; G01L 1/22; B60T 17/22

(52) U.S. Cl. CPC B60T 17/083; B60T 17/221; G01L 1/22; F16D 2066/003

(57) ABSTRACT

A brake cylinder of a motor vehicle, in particular a pneumatically actuatable brake cylinder of a commercial vehicle, includes a first housing part and a second housing part. An actuation tappet actuates a brake lever of a brake application device, which actuation tappet protrudes from a spring chamber of the first housing part. A membrane, which divides an interior bounded by the first housing part and the second housing part into a pressure chamber and the spring chamber, is provided, as well as a return spring for returning the actuation tappet from a braking position to a non-braking position. The return spring is arranged in a loaded manner between a housing bottom of the first housing part and a plate, which is arranged on the spring chamber side of the membrane and is connected to the actuation tappet. The return spring is provided with at least one elongation-measuring element.

### CROSS REFERENCE TO RELATED APPLICATIONS

This application is a continuation of PCT International Application No. PCT/EP2016/057603, filed Apr. 7, 2016, which claims priority under 35 U.S.C. § 119 from German Patent Application No. 10 2015 105 349.7, filed Apr. 9, 2015, the entire disclosures of which are herein expressly incorporated by reference.

### BACKGROUND AND SUMMARY OF THE INVENTION

The present invention relates to a brake cylinder of a motor vehicle, in particular a pneumatically actuatable brake cylinder of a commercial vehicle.

A generic brake cylinder is, for example, known from DE 102 36 923 B4. The brake cylinder set out in this document is a so-called combination brake cylinder having a service brake unit which is arranged in a service brake cylinder portion and a parking brake unit which is arranged in a parking brake cylinder portion.

The service brake unit has in this instance substantially one actuation tappet which is used to actuate a brake lever of a brake application device. The service brake unit of the brake cylinder is in this instance divided by a diaphragm into a spring chamber and a pressure chamber. In this instance, at a side of the diaphragm facing the spring chamber, there is arranged a plate which is connected to the actuation tappet. When pressure is applied to the pressure chamber, the diaphragm is pressed in the direction of the spring chamber. In this instance, the actuation tappet is pressed slightly out of the first housing portion in the direction of the brake lever and in this instance actuates the brake lever and consequently the brake application device which brings about pressing of brake pads or linings against a brake disk or a brake drum of a vehicle wheel in order to brake the motor vehicle. If the braking operation is ended, a restoring spring which is arranged so as to be clamped between a housing base of the first housing portion and a plate which is arranged at the spring chamber side of the diaphragm, and which is connected to the actuation tappet, presses the actuation tappet back into its original or non-braking position.

From the position of the actuation tappet, conclusions can be drawn relating to the correct operating method of the motor vehicle brake and, in particular, the brake cylinder. It is thus possible from the travel path of the actuation tappet to draw conclusions relating to the play and possible incorrect behavior of an adjustment mechanism of the motor vehicle brake. Compressed air valves which are not operating correctly may also be the cause of a changed travel path of the actuation tappet.

In order to determine necessary information in the case of such compressed-air-actuated wheel brakes with regard to the play, the correct function of the adjustment mechanism or also the compressed air valves of the brake cylinder, it is known to disassemble a respective vehicle wheel from the wheel brake in order to subsequently carry out a manual examination of the brake components.

From WO 2011/160028 A1, there is known an electronic travel sensor system by means of which such a complex disassembly of the vehicle wheel in order to examine the components mentioned can be avoided. In this instance, a sensor element is installed between the actuation tappet and a connection flange of the brake cylinder on a brake caliper of the wheel brake in order to visually detect the travel of the actuation tappet.

The disadvantage of this solution is that the installation of the sensor element makes processing of the interface between the brake cylinder and the brake caliper necessary. Furthermore, in the travel sensor system described in the above-mentioned document, a processing of the actuation tappet itself with respect to an actuation tappet known, for example, from DE 102 36 923 B4 is also required.

An object of the present invention is to provide a brake cylinder of a motor vehicle by which an examination of the mentioned components is enabled without disassembly of the vehicle wheel and by which a sensor system of the travel of the actuation tappet is enabled without components which are present being processed.

This object is achieved with a brake cylinder of a motor vehicle according to embodiments of the invention.

The brake cylinder according to the invention, in particular a pneumatically actuatable brake cylinder of a commercial vehicle, has a first housing portion and a second housing portion. An actuation tappet for actuating a brake lever of a brake application device protrudes from a spring chamber of the first housing portion. The inner space delimited by the first housing portion in the second housing portion is subdivided by a diaphragm into a pressure chamber and a spring chamber. A restoring spring for restoring an actuation tappet from a braking position into a non-braking position is arranged in the spring chamber. The restoring spring is arranged so as to be clamped between a housing base of the first housing portion and a plate which is arranged at the spring chamber side of the diaphragm and which is connected to the actuation tappet. In order to detect the travel of the actuation tappet, the restoring spring is provided with at least one expansion measurement element.

It is thereby possible, from the expansion shearing of the restoring spring which is in abutment at one end with the plate connected to the actuation tappet, to draw conclusions relating to the travel of the actuation tappet and consequently the play, any present incorrect behavior of an adjustment mechanism, incorrectly operating compressed air valves or also malfunctions in the brake system as a result of penetrating liquid.

In the event of damage, it is thus possible to identify and overcome the error which has occurred in a selective manner.

Furthermore, no additional sealing face is required at the interface between the brake cylinder and brake caliper, whereby the robustness of the brake cylinder is further increased.

According to an advantageous embodiment, the expansion measurement element is constructed as an expansion measurement strip. Such an expansion measurement strip can be fitted in a simple manner to the restoring spring without having to change the restoring spring itself or another component of the brake cylinder.

The expansion measurement strip is in this instance in a particularly preferred manner arranged on the restoring spring in such a manner that it surrounds a peripheral portion of the restoring spring so that with reference to the bending of this portion of the restoring spring conclusions can be drawn relating to the movement state of the restoring spring relative to an initial state, for example, the maximum relaxed non-braking position in a simple manner.

The expansion measurement element is according to another advantageous embodiment coupled to a display, in particular a control display in a driver's cab of the motor vehicle, so that the motor vehicle driver can access at any time information relating to the correct function of the actuation tappet.

In a particularly preferred manner, the expansion measurement element is connected by means of a cable to the control display and/or an electronic evaluation system. Such a cable can be fixed in a simple manner to the restoring spring and can be guided from the end of the restoring spring along and out of the first housing portion.

A wireless connection of the expansion measurement element to the control display and/or the electronic evaluation system is also contemplated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a lateral sectioned view of an embodiment of a brake cylinder according to an embodiment of the invention.

FIG. 2 is a schematic illustration of an expansion measurement element arranged on a restoring spring and the connection thereof to an electronic evaluation system and a control display.

### DETAILED DESCRIPTION OF THE DRAWINGS

In the following description of the Figures, the terms such as top, bottom, left, right, front, rear, etc., refer exclusively to the exemplary illustration selected in the respective Figures and position of the brake cylinder, the housing components, the diaphragm, the restoring spring, the actuation tappet and the like. These terms are not intended to be understood to be limiting, that is to say, as a result of different operating positions or the mirror-symmetrical configuration or the like, these references may change.

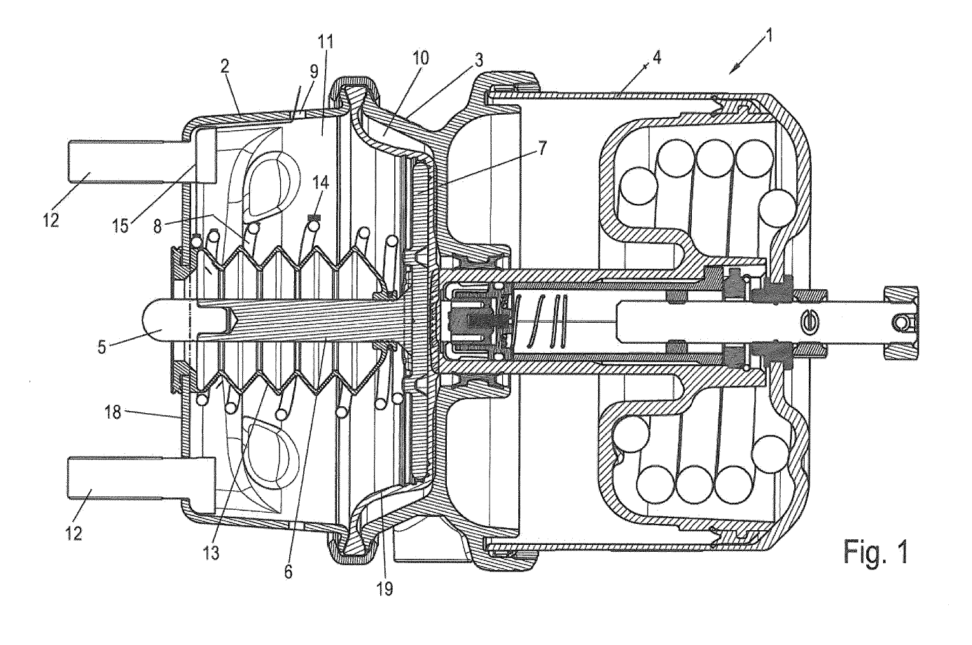

In FIG. 1, an embodiment of a brake cylinder of a motor vehicle, in particular a pneumatically actuatable brake cylinder of a commercial vehicle, is generally designated with the reference numeral 1.

The brake cylinder 1 has a first housing portion 2 with a housing base 18 thereof connected to a connection flange of a brake caliper (not shown).

At a side of the first housing portion 2 facing away from the housing base 18 there is arranged a second housing portion 3 which connects the first housing portion 2 to a third housing portion 4. In this case, a parking brake unit is preferably installed in the third housing portion 4, whilst a service brake unit is installed in the first housing portion 2. The basic structure and the operating method of this brake cylinder 1 is, for example, described in DE 102 36 923 B4, the content of which is incorporated by reference herein as non-essential subject matter in order to explain various details of the brake cylinder, which is referred to therein as a spring energy storage cylinder.

The construction of the service brake unit is significant for the invention. In this regard, it is also contemplated according to the invention for the brake cylinder 1 to be constructed only from the service brake unit and, consequently, from the first housing portion 2 and the second housing portion 3, with the components of the service brake unit accommodated in the inner space between the two housing portions 2, 3.

The service brake cylinder portion whose inner space is delimited by the first housing portion 2 and the second housing portion 3 has a diaphragm 19 which subdivides the inner space of the service brake cylinder portion into a pressure chamber 10 and a spring chamber 11.

At the side of the diaphragm 19 facing the spring chamber 11, there is arranged a plate 7 from which the actuation tappet 5, which is in this instance, formed by a pressure piece and a piston rod 6 which extends from the plate 7, extends through an opening in the housing base 18 of the first housing portion 2 in the direction of a brake lever (not shown).

Between the housing base 18 of the first housing portion 2 and the plate 7 which is arranged at the spring chamber side of the diaphragm 19 and which is connected to the actuation tappet 5, a restoring spring 8, which is preferably constructed as a helical spring, is arranged in a tensioned manner. This restoring spring 8 serves to retain the actuation tappet 5 from a braking position, in which the actuation tappet 5 protrudes extensively from the housing base 18 of the first housing portion 2, into a non-braking position deep inside the first housing portion 2.

In the case of a service braking operation, as a result of a brake pedal which is actuated by the vehicle driver, the pressure chamber 10 is acted on with compressed air which leads to the diaphragm 19 bending in the direction of the housing base 18 of the first housing portion 2 and in this instance pressing the plate 7 and, consequently, the actuation tappet 5 extensively out of the spring chamber 11 of the first housing portion 2. This actuates the brake lever of the brake application device and consequently initiates a braking operation.

In order to protect the actuation tappet 5 from contamination, there is provided a folding bellows 13 which is secured between the housing base 18 and on the piston rod 6 close to the plate 7.

In order to secure the first housing portion 2 to a brake caliper, stud bolts 12 which are anchored to the housing base 18 and which protrude into the brake caliper are provided.

In order to determine the travel of the actuation tappet 5 relative to the housing base 18 of the first housing portion 2, the restoring spring 8 is provided with at least one expansion measurement element 14 by which the expansion, in particular shearing expansion, of the material of the restoring spring 8 can be measured.

This expansion measurement element 14, which is preferably constructed as an expansion measurement strip in this instance, is fitted to a peripheral portion of the restoring spring.

In a particularly preferred manner, the expansion measurement strip is fitted to the peripheral portion of the restoring spring 8 in such a manner that it surrounds it. Since the translational movement of the actuation tappet 5 during a braking operation involves compression of the restoring spring 8, it is possible from the shearing strain which occurs in the restoring spring 8 to draw conclusions relating to the current travel of the actuation tappet 5.

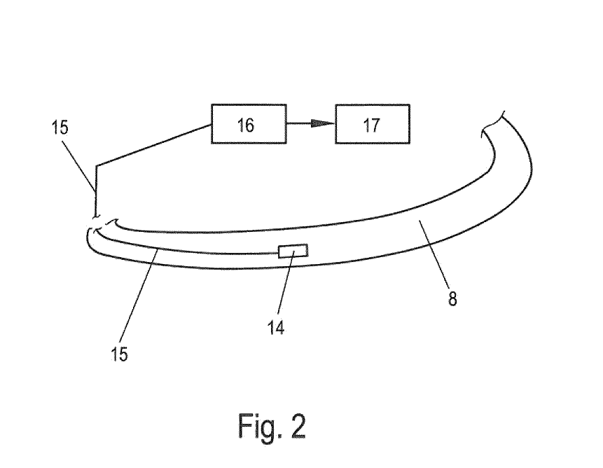

As illustrated in particular in the schematic illustration of FIG. 2, the expansion element 14 is preferably connected by way of an electrical cable which is laid along the restoring spring 8 to an electronic evaluation system 16 by which the signal which is transmitted from the expansion measurement element 14 is preferably displayed in a display 17 in the driver's cab of the motor vehicle.

Here, the electronic evaluation system 16 substantially comprises a bridge amplifier. Depending on the spring characteristic line of the restoring spring 8, the electronic evaluation system 16 further has components in order to produce the measurement signal of the expansion measurement element 14 as long as the restoring spring 8 has a non-linear spring characteristic line.

It is also contemplated in the case of a non-linear spring characteristic line of the restoring spring 8 by fitting a plurality of such expansion measurement elements 14 to the restoring spring 8 to connect the expansion measurement elements 14 to each other by way of a differential circuit.

It is also contemplated to provide the expansion measurement element 14 with a transponder by which a wireless transmission of the signal of the expansion measurement element 14 to the electronic evaluation system 16 can be carried out wirelessly.

In the construction variant shown in FIG. 1, the cable 15 is preferably first guided along the restoring spring 8 and subsequently along the housing base 18 of the first housing portion 2 as far as an opening 9 in the first housing portion 2 and through it out of the first housing portion 2. This opening 9 in the first housing portion 2 further serves to connect the spring chamber 11 to the ambient air.

It is important that, in order to install the expansion measurement element 14, no structural change of the brake cylinder 1 which is provided is required so that such an expansion measurement element 14 where applicable can also be retrofitted in available vehicles.

### LIST OF REFERENCE NUMERALS

1 Brake cylinder
2 First housing portion
3 Second housing portion
4 Third housing portion
5 Actuation tappet
6 Piston rod
7 Plate
8 Restoring spring
9 Opening
10 Pressure chamber
11 Spring chamber
12 Stud bolt
13 Folding bellows
14 Expansion measurement element
15 Cable
16 Electronic evaluation system
17 Display
18 Housing base
19 Diaphragm

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake cylinder of a motor vehicle, comprising:
a first housing portion and a second housing portion;
an actuation tappet which protrudes from a spring chamber of the first housing portion for actuating a brake lever of a brake application device;
a diaphragm which subdivides an inner space which is delimited by the first housing portion and the second housing portion into a pressure chamber and the spring chamber;
a restoring spring for restoring the actuation tappet from a braking position into a non-braking position;
wherein the restoring spring is arranged so as to be clamped between a housing base of the first housing portion and a plate which is arranged at the spring chamber side of the diaphragm and which is connected to the actuation tappet; and
wherein the restoring spring is provided with at least one expansion measurement element.

2. The brake cylinder as claimed in claim 1, wherein the brake cylinder is a pneumatically actuatable brake cylinder of a commercial vehicle.

3. The brake cylinder as claimed in claim 1, wherein the expansion measurement element is constructed as an expansion measurement strip.

4. The brake cylinder as claimed in claim 3, wherein
the expansion measurement strip surrounds a peripheral portion of the restoring spring.

5. The brake cylinder as claimed in claim 1, wherein
the expansion measurement element is coupled to a display.

6. The brake cylinder as claimed in claim 5, wherein the display is a control display.

7. The brake cylinder as claimed in claim 6, wherein
the expansion measurement element is connected to the control display by an electronic evaluation system.

8. The brake cylinder as claimed in claim 6, wherein
the expansion measurement element is connected by a cable to the control display and/or the electronic evaluation system.

9. The brake cylinder as claimed in claim 6, wherein
the expansion measurement element is connected to the control display and/or the electronic evaluation system in a wireless manner.
